(19) United States
(12) Patent Application Publication
(10) Pub. No.: US 2008/0202407 A1
(43) Pub. Date: Aug. 28, 2008

(54) Theft Deterrent System and a Device For Use in Said System

(76) Inventor: Rolf B. Jorgensen, Graested (DK)

Correspondence Address: GIFFORD, KRASS, SPRINKLE,ANDERSON & CITKOWSKI, P.C, PO BOX 7021, TROY, MI, 48007-7021, US

(21) Appl. No.: 11/916,666

(22) PCT Filed: Jun. 1, 2006
(86) PCT No.: PCT/DK2006/000306

§ 371 Date: Mar. 19, 2008

(30) Foreign Application Priority Data
Jun. 6, 2005 (DK) PA2005 00824
Jan. 9, 2006 (DK) PA2006 00037

(51) Int. Cl. G08B 13/14

(52) U.S. Cl. 116/75

(57) ABSTRACT

The invention concerns a theft deterrent device (1), such as a tag, which is attachable to an article (3), to indicate the unauthorized removal of the article from a given area such as a retail establishment, said device comprising: at least one fluid (5)-containing member; a active staining substance (5) to be contained in said fluid-containing member; a housing (4) which encloses said fluid-containing member; means (6) for attaching the housing to the articles to be protected; means (7) for releasing the fluid from the fluid-containing member in response to unauthorised removal of the article, wherein the active staining substance in the fluid-containing member is a malodorous substance, and that said active substance subsequent to having impacted the article with the malodorous odour is capable of being neutralised by a corresponding counter substance. By a theft deterrent device according to the invention, there is provided an anti theft technology which contains the possibility for recycling the articles as a sales object again by neutralising the active substance if the articles are found again.

The present invention relates to a theft deterrent system and a device, in particular a tag, which is attachable to a product or the like.

It is known to use a system of such kind to indicate the unauthorized removal of merchandise from a given area such as a retail establishment.

In particular, it is known to use an anti-theft ink device in the form of a tag designed to permanently render an article useless if unauthorized removal of the tag is attempted. The anti-theft ink tag includes ampoules containing a permanent staining substance. The ampoules are supported in a base component with holes that allow the staining substance to escape if the ampoules are fractured. A cover component with a break away element covers the base component. Permanently attached to the break away element is an elongated pin type connecting unit that is used to attach the tag to the article being protected, and locked into place by a locking mechanism. When an unauthorized removal of the tag is attempted, the break away element fractures the ampoules and also exposes the outside of the cover component to the staining substance. Another release mechanism could be en electronic activation, e.g. an EAS system (EAS: Electronic Article Surveillance).

Examples of such anti-theft ink tags are described in U.S. Pat. No. 5,852,856, U.S. Pat. No. 5,680,681 and U.S. Pat. No. 5,309,740.

In U.S. Pat. No. 4,698,620, a similar fluid-containing security device is described wherein a detection fluid is released if a fluid containing member is activated by an attempt to unauthorised removal of the device from the article to which it is attached. The detection fluid may be a gas, a liquid or a mixture thereof and it may be a colouring agent, an odour containing fluid, a fluorescent or a radioactive material or the like. In the retail business there are many examples that this ink tag technology is used on garment where the removal of the theft deterrent ink tag causes detonation and discolouring of the garment. By this kind of anti theft surveillance devices, the merchandise cannot be resold or used if it is found later on.

Some merchants find such anti-theft ink tags unsuitable at least for some types of articles as an activation of the colouring agent causes a destruction of the article. Another drawback of these ink tags is also the risk of destruction of the articles if a mistake is made during the authorised removal or the attachment of the tag to the article.

For these reasons, it is an object of the present invention to provide a theft deterrent system, which eliminates the drawbacks of the known systems.

This object is achieved by a theft deterrent system and a device, such as a tag, for use in such system, said device being attachable to an article to indicate the unauthorized removal of the article from a given area such as a retail establishment, said device comprising: at least one fluid-containing member; a active staining substance to be contained in said fluid-containing member; a housing which encloses said fluid-containing member; means for attaching the housing to the articles to be protected; means for releasing the fluid from the fluid-containing member in response to unauthorised removal of the article, wherein the active staining substance in the fluid-containing member is an odour containing fluid, such as a malodorous substance, and that said active substance subsequent to having impacted the article with the traceable odour of the odour containing fluid is capable of being neutralised by a corresponding counter substance.

By a theft deterrent system according to the invention, there is provided an anti theft technology which contains the possibility for recycling the articles as a sales object again by neutralising the active substance if the articles are found again.

The theft deterrent device according to the invention may be in the form of a tag detachably attached to the article as well as a device permanently attached to the article. The article could be garment, pillows, furniture as well as other retail merchandise. It is also realised that the technology according to the invention could be used as a theft deterrent device in cars, exhibits in museums, such as paintings, sculptures, etc.

The device according to the invention may be used separately or together with a colouring ampoule, e.g. for being able to track the stolen goods.

Contrary to the colouring agent in the ink tags, a device according to the invention does not permanently damage the articles, as the traceable odour, such as a malodorous substance, can be neutralised and removed by the application of a corresponding counteracting substance. The neutralising substance could be sprayed onto the article or otherwise applied in order to restore the article in its original condition. This makes the device according to the invention suitable for use in more costly products where an anti-theft ink tag is considered unsuitable due to the cost of the damages the tag can do to the product it is attached to. Examples of such products could be e.g. furniture and automobile vehicles.

In a preferred embodiment, the fluid-containing member is an ampoule which is mounted in said housing in such a way that unauthorized removal of said device causes said ampoules to fracture which allow said active traceable odour to escape.

In one embodiment, the means for releasing the fluid comprises an electronic circuit which is activated if the device is removed from a defined area. By using such electronic activation means, the device can be deactivated when the article is sold in a legal way. If the electronic activation circuit is not deactivated, it may automatically be activated if the article is removed from a predefined area whereby the device is detected and an electronic signal is send to the device causing the release of the substance.

In another embodiment, the means for releasing the fluid comprises a release mechanism which cooperates with the means for attaching the housing to the article.

The device may be removed in an authorised manner by the retail establishment upon sale without releasing the fluid substance.

The active malodorous substance may be selected from a group consisting of butyric acid, pentancarboxyl and hexancarboxyl. Correspondingly, the neutralising substance may include acid and alcohols of the ester group for changing the butyric acid to butholates, salts and esters. By using an ampoule with butyric acid, the acid can be added some special salts and naturally occurring alcohols whereby a change of the pH value will happen and the malodorous smell can be converted to a pleasant odour. This can be achieved by applying the corresponding neutralising substance. In an example of an embodiment of the invention, the substance could be based on butyric acid. The neutralising agent in this example may advantageously be an alkaline solution.

For a specific retailer or the like making use of a theft deterrent system according to the invention, an individually selected active malodorous substance is selected, such that a specific neutralising substance must be used to counteract the malodorous effect by release of the substance.

To the traceable odour containing fluid may be added a colour agent, which is also neutralisable by the corresponding neutralising agent. Hereby, a stain from an ampoule which e.g. may have been broken in error can be clearly visible and neutralised. The stains become visible and can therefore quickly and efficiently be neutralised. By the term colour is meant any visually detectable agent or substance.

In a preferred embodiment, the malodorous substance is added a colour so that it is immediately visible where the active deterrent substance is present. It is also suggested that a relatively complex compound is provided, which will provide a good wetting properties and which is more difficult to identify.

The unpleasant smell and the colour will disappear by the addition of a neutralising agent, which preferably is provided with a pleasant smell and surface active substances. The colour of the smell deterrent substance provides a possibility of ensuring that all of the released substance is neutralised.

The malodorous substance could be provided as a fluid, in particular a liquid or a semi-solid consistency, i.e. a gel, but could as an alternative also be provided in a granular form, such as a powder, which in relation to some merchandise could be more advantageous.

In the following, the invention is described with reference to the accompanying drawings, in which:

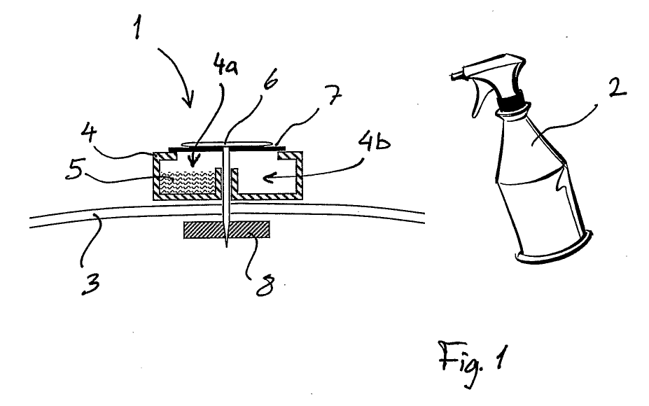

FIG. 1 is a schematic illustration of the system according to the invention;

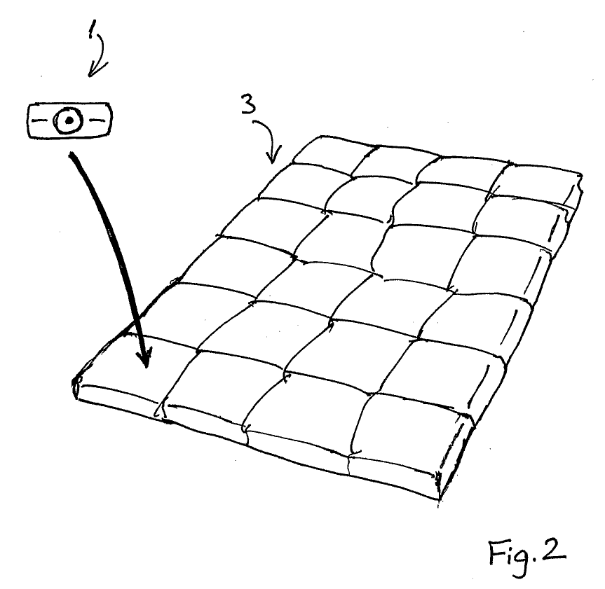

FIG. 2 is an illustration of the system used in a retail article, and

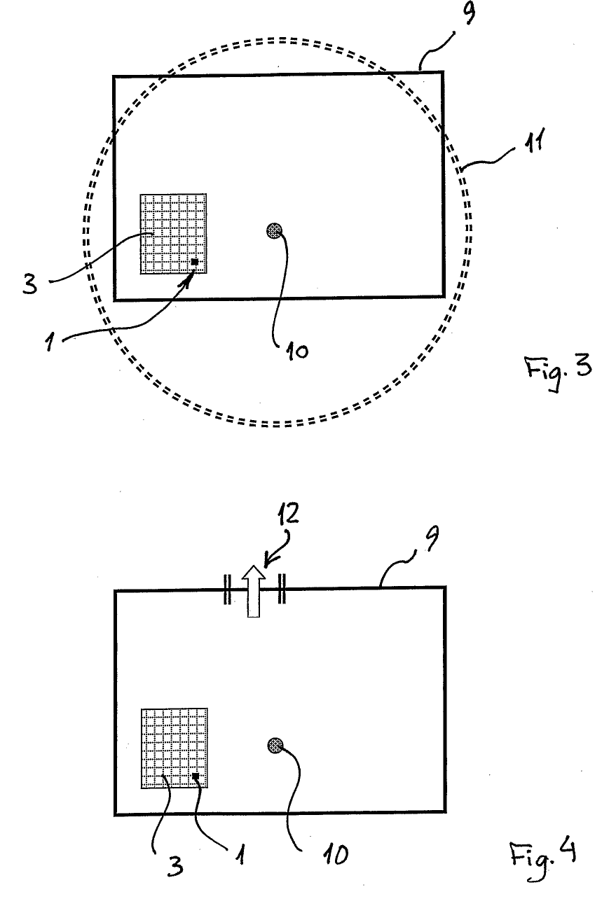

FIGS. 3 and 4 are examples of release systems in a retail business.

With reference to FIGS. 1 and 2, the theft deterrent system according to the invention includes a theft deterrent device 1 which is attachable to a product 3, such as a duvet as shown in FIG. 2, a sofa, a chair, etc. The device contains a housing 4 with one or more fluid containers 4a, 4b in which an odour containing fluid 5 is accommodated, such as a malodorous liquid. This liquid is sealed inside the at least one container 4a, 4b by appropriate sealing means 7 and releasably attached to the product 3 via an attachment pin 6 which cooperates with a locking means for fixing the device to the product 3. Various systems including tags for attaching and releasing a fluid when trying to remove the tag from the product in an unauthorised manner are known. Other release systems could be electronically activated systems.

This fluid 5 releases a significant smell which makes the product 3 traceable. However rather than ruining the product 3 by the release of such anti theft tag device 1, the odour fluid is designed in such a manner that a corresponding neutralising substance 2 is provided which as indicated in FIG. 1 may be sprayed onto the product 3 to neutralise the released odour from the fluid 5.

The device 1 may be attached visibly on the products 3 but could alternatively be embedded in the product 3 as suggested in FIG. 2. This embodiment would suggest the use of an electronic activation system with means (not shown) to deactivate the tag inside the product 3.

As indicated in FIGS. 3 and 4, the electronic activation could trigger the odour fluid release in different manner.

In a first embodiment, a boundary outside 11 the retail shop 9 is defined by suitable electronic equipment 10 and if the product 3 containing the odour fluid containing device 1 is taken outside this boundary this would cause the fluid release and thereby staining the product with a significant and traceable smell.

In a second embodiment, a gateway 12 is defined. This would typically be the entrance to the shop 9. If the product 3 is taken through the gateway with the device 1 attached to the product 3 and the device 1 has not been deactivated or removed in an authorised manner in connection with a purchase the passage through the gateway 12 would trigger the fluid release.

The odorous fluid is composed with specific ingredients so that only matching counter-substances are successful in neutralising the smell. The fluid may be specific for a particular retail business, i.e. for a batch of anti-theft devices, so that a retail business can use the same neutralising substance for all the devices planted on their products.

### EXAMPLE

Examples of fluids for a theft deterrent device where the active substance is neutralised by a counter substance are listed below.

The active, smell deterrent fluid is made of:

| | | |
|---|---|---|
| 40 ± 0.1% | v/v | Butyric acid; CH₃CH₂CH₂CO₂H |
| 20 ± 0.1% | v/v | Isovaleric acid; (CH₃)₂CHCH₂CO₂H |
| 20 ± 0.1% | v/v | Isopropanol; (CH₃)₂CCHOH |
| 20 ± 0.1% | v/v | Distilled water |
| 0.1% | w/v | Acid fuchsin; C₂₀H₁₇N₃Na₂O₉S₃ |

The content of the corresponding neutralising fluid is:

| | | |
|---|---|---|
| 8 ± 0.2% | w/v | Sodium hydroxide; NaOH |
| 92 ± 0.2% | v/v | Distilled water |
| 0.2% | v/v | Citric oil/anionic/non-ionic detergents |

In a first preferred embodiment, the malodorous substance is provided in liquid form in the fluid-containing member. However, as an alternative it is realised by the invention that the odour containing fluid having a traceable odour, such as a malodours substance, may be provided in a granular form. The granular material may be accommodated in the fluid container in a manner equivalent to the liquid. Upon release, the granulate will cause a smell and spread sufficient in response to unauthorised removal of the anti-theft device from the article to which it was attached.

The amounts of the individual ingredients may vary beyond the ranges indicated without compromising the (mal-)odorous effect respectively the neutralising effect of the substances.

The odour of the odour containing fluid may be a malodorous substance as described in the example above. However, it is realised that any suitable odour, including e.g. strong fragrants, may be used as long as it is traceable and capable of being neutralised.

It is also realised that other variants of the “active” odorous substance and its counter-substance may be provided without departing from the scope of the invention, as defined in the accompanying claims.

The use of the term retail business in the explanatory examples above, there is meant any user of a traceable odorous fluid system according to the invention, i.e. also garages, museums, private homes and other businesses and organisations, etc. where an unauthorised removal of goods is to be traced.

1. A theft deterrent system comprising
a device, such as a tag, which is attachable to an article, to indicate the unauthorized removal of the article from a given area such as a retail establishment; said device comprising:
at least one fluid-containing member;
an active staining substance to be contained in said fluid-containing member;
a housing which encloses said fluid-containing member;
means for attaching the housing to the articles to be protected;
means for releasing the fluid from the fluid-containing member in response to unauthorised removal of the article, wherein
the active staining substance in the fluid-containing member is an odour containing fluid having a traceable odour, and
a counter substance corresponding to said active substance, so that subsequent to having impacted the article with the odour containing fluid, said odour containing fluid is capable of being neutralised by said corresponding counter substance.

2. A theft deterrent system according to claim 1, wherein the fluid-containing member is an ampoule which is mounted in said housing in such a way that unauthorized removal of said device causes said ampoule to fracture which allows said active odour containing fluid to escape.

3. A theft deterrent system according to claim 1, wherein the means for releasing the fluid comprises an electronic circuit which is activated if the device is removed from a defined area.

4. A theft deterrent system according to claim 1, wherein the means for releasing the fluid comprises a release mechanism which cooperates with the means for attaching the housing to the article.

5. A theft deterrent system according to claim 1, wherein the active odorous substance of the odour containing fluid may be is selected from the group consisting of butyric acid, pentancarboxyl and hexancarboxyl.

6. A theft deterrent system according to claim 5, wherein the neutralising substance includes acid and alcohols of the ester group for changing the butyric acid to butholates, salts and esters.

7. A theft deterrent system according to claim 1, wherein the odour containing fluid further includes a colour agent which is also neutralisable by the corresponding neutralising agent.

8. A theft deterrent system according to claim 1, wherein the neutralising agent is provided with a detergent.

9. A theft deterrent system according to claim 1, wherein the odour containing fluid is a malodorous substance.

10. A theft deterrent system according to claim 1, wherein the odour containing fluid is an odour releasing gel.

11. A theft deterrent device, which is attachable to an article, to indicate the unauthorized removal of the article from a given area; said device comprising:
at least one fluid-containing member;
an active staining substance to be contained in said fluid-containing member;
a housing which encloses said fluid-containing member;
means for attaching the housing to the articles to be protected;
means for releasing the fluid from the fluid-containing member in response to unauthorised removal of the article
characterised in that
the active staining substance in the fluid-containing member is an odour containing fluid having a traceable odour, and that
said active substance subsequent to having impacted the article with the odour containing fluid is capable of being neutralised by a corresponding counter substance.

12. A theft deterrent device according to claim 11, wherein the fluid-containing member is an ampoule which is mounted in said housing in such a way that unauthorized removal of said device causes said ampoule to fracture which allows said active odour containing fluid to escape.

13. A theft deterrent device according to claim 11, wherein the means for releasing the fluid comprises an electronic circuit which is activated if the device is removed from a defined area.

14. A theft deterrent device according to claim 11, wherein the means for releasing the fluid comprises a release mechanism which cooperates with the means for attaching the housing to the article.

15. A theft deterrent device according to claim 11, wherein the active odorous substance of the odour containing fluid is selected from the group consisting of butyric acid, pentancarboxyl and hexancarboxyl.

16. A theft deterrent device according to claim 15, wherein the neutralising substance includes acid and alcohols of the ester group for changing the butyric acid to butholates, salts and esters.

17. A theft deterrent device according to claim 11, wherein the odour containing fluid includes a colour agent which is also neutralisable by the corresponding neutralising agent.

18. A theft deterrent device according to claim 11, wherein the neutralising agent is provided with a detergent.

19. A theft deterrent device according to claim 11, wherein the odour containing fluid is a malodorous substance.

20. A theft deterrent device according to claim 11, wherein the odour containing fluid is an odour releasing gel.

21. A method of recovering an article stained by the content of a theft deterrent device which is attachable to an article, to indicate the unauthorized removal of the article from a given area such as a retail establishment, where an odour containing fluid has been released from the device and applied a malodorous odour to the article, said method comprising the step of counteracting the odour containing fluid by applying a counteracting neutralising substance to the article.

22. A method according to claim 21, whereby the neutralising substance is sprayed onto the article.

23. A method according to claim 21, whereby the odour containing fluid is a malodorous theft indicating substance.
